(19) United States
(12) Patent Application Publication
(10) Pub. No.: US 2012/0242587 A1
(43) Pub. Date: Sep. 27, 2012

(54) CHARACTER RECOGNITION SYSTEM

(75) Inventors: Alfred C. TOM, San Francisco, CA (US); Frances H. JAMES, Sunnyvale, CA (US); Kelly KODAMA, Walnut Creek, CA (US); Fadhly BEY, San Francisco, CA (US); Julian PECK, San Rafael, CA (US); James EWAN, Los Altos, CA (US); Matt PALLAKOFF, Mountain View, CA (US)

(73) Assignee: GM GLOBAL TECHNOLOGY OPERATIONS LLC, DETROIT, MI (US)

(21) Appl. No.: 13/072,485

(22) Filed: Mar. 25, 2011

(51) Int. Cl. G06F 3/041

(52) U.S. Cl. 345/173

(57) ABSTRACT

A character recognition system includes, but is not limited to, a touchpad including a touch sensing surface for generating a first signal in response to a touch, the first signal corresponding to a location of the touch on the touch sensing surface, the touchpad further including a topographical feature associated with the touch sensing surface, the topographical feature configured to guide a touching member in a predetermined pattern along the touch sensing surface, the predetermined pattern corresponding with a predetermined set of characters. The system also includes an output device for communicatively coupling with a controlled device. The system further includes a processor communicatively coupled with the touchpad and the output device. The processor receives the first signal, detects a pattern of the touch, generates a second signal corresponding to the pattern, and instructs the output device to output the second signal.

### TECHNICAL FIELD

The technical field generally relates to an input system, and more particularly relates to a character recognition system.

### BACKGROUND

A vehicle occupant encounters an ever increasing array of electronic devices in the passenger compartment of a vehicle and elsewhere. Several types of electronic devices may rely on input from the occupant in the form of characters or a string of characters. Accordingly, such devices may rely on attention from the vehicle occupant when data is entered. In many instances, the vehicle occupant may not only extend their reach to physically touch the device to provide the input, but may also need to look at the device to ensure that an appropriate character is being entered. However, due to other demands on the attention of the vehicle occupant, it may be undesirable for the vehicle occupant to provide this level of attention to the electronic device.

One existing solution to this situation is to position a touchpad near the vehicle occupant. The touchpad is configured to receive inputs in the form of a touch from the vehicle occupant and to deliver the inputs to the electronic device (referred to hereinafter as the “controlled device”). When a touchpad is used, the vehicle occupant may interact with the touchpad without taking their eyes off of the road to search for the controlled device and without having to reach for a dedicated input mechanism collocated with the controlled device. Rather, the touchpad may be conveniently located near an armrest or some other location in the passenger compartment that is readily accessible to the vehicle occupant. To provide an input, the vehicle occupant need only trace one or more characters on a touch sensitive surface of the touchpad with their finger.

While this solution is adequate, there is room for improvement. For example, in the event of a turbulent ride or as a result of the forces experienced during vehicle maneuvers, a vehicle occupant attempting to enter an input by tracing their finger along the touch sensitive surface of the touchpad may make an errant movement that may render the input unrecognizable. Additionally, a vehicle occupant attempting to sketch a particular character across the touch sensitive surface of the touchpad without looking at the touchpad may make an error. And even when a vehicle occupant is looking at the touchpad, differences in each occupant's handwriting may, nevertheless, cause a vehicle occupant to trace an unrecognizable input across the touch sensitive surface of the touchpad.

### SUMMARY

Various embodiments of a character recognition system are disclosed herein.

In a first embodiment, the character recognition system includes, but is not limited to, a touchpad that includes a touch sensing surface that is configured to generate a first signal in response to a touch on the touch sensing surface. The first signal corresponds to a location of the touch on the touch sensing surface. The touchpad further includes a topographical feature that is associated with the touch sensing surface. The topographical feature is configured to guide a touching member in a predetermined pattern along the touch sensing surface. The predetermined pattern corresponds with a predetermined set of characters. The system further includes an output device that is configured to be communicatively coupled with a controlled device. The system still further includes a processor that is communicatively coupled with the touchpad and the output device. The processor is configured to receive the first signal, to detect a pattern of the touch, to generate a second signal corresponding to the pattern of the touch, and to instruct the output device to output the second signal when the processor generates the second signal.

In another embodiment, the character recognition system includes, but is not limited to, a touchpad that includes a touch sensing surface that is configured to generate a first signal in response to a touch on the touch sensing surface. The first signal corresponds to a location of the touch on the touch sensing surface. The touchpad further includes a topographical feature that is associated with the touch sensing surface. The topographical feature is configured to guide a touching member in a predetermined pattern along the touch sensing surface. The predetermined pattern corresponds with a predetermined set of characters. The system further includes an output device that is configured to be communicatively coupled with a controlled device. The system further includes a first processor that is communicatively coupled with the touchpad and the output device. The first processor is configured to receive the first signal, to detect a pattern of the touch, to generate a second signal corresponding to the pattern of the touch, and to instruct the output device to output the second signal when the first processor generates the second signal. The system still further includes a controlled device that is communicatively coupled with the output device. The controlled device is configured to receive the second signal from the output device. The controlled device includes a controlled element and a second processor coupled to the controlled element. The second processor is configured to recognize the predetermined set of characters and to send an instruction to the controlled element when the second processor determines that the second signal corresponds with a character of the predetermined set of characters.

In another embodiment, the character recognition system includes, but is not limited to, a touchpad that includes a touch sensing surface that is configured to generate a first signal in response to a touch on the touch sensing surface. The first signal corresponds to a location of the touch on the touch sensing surface. The touchpad further includes a topographical feature that is associated with the touch sensing surface. The topographical feature is configured to guide a touching member in a predetermined pattern along the touch sensing surface. The predetermined pattern corresponds with a predetermined set of characters. The system further includes an output device that is configured to be communicatively coupled with a controlled device. The system still further includes a processor that is communicatively coupled with the touchpad and the output device. The processor is configured to receive the first signal, to detect a pattern of the touch, to recognize the predetermined set of characters, to generate a second signal corresponding to a character of the predetermined set of characters when the pattern of the touch corresponds with the character, and to instruct the output device to output the second signal to the controlled device when the processor generates the second signal.

### DESCRIPTION OF THE DRAWINGS

One or more embodiments will hereinafter be described in conjunction with the following drawing figures, wherein like numerals denote like elements, and

FIG. 1 is a schematic view of various embodiments of a character recognition system;

FIG. 2 is a schematic view of another embodiment of a character recognition system;

FIG. 3 is a perspective view of the passenger compartment of the vehicle equipped with an embodiment of the character recognition system of FIG. 1;

FIG. 4 is an expanded view of a touch sensing surface and a topographical feature for use with the character recognition system of FIG. 1;

FIG. 5 is an expanded view of the touch sensing surface and another embodiment of the topographical feature of FIG. 4 for use with the character recognition system of FIG. 1;

FIG. 6 is a plan view of the touch sensing screen of the character recognition system of FIG. 5 illustrating the input of the letter “A”; and

FIG. 7 is a perspective fragmentary view of a portion of a housing of the touchpad of the character recognition system of FIG. 3 illustrating various output devices that are compatible with the character recognition system.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

An improved character recognition system is disclosed herein that includes a touchpad and topographical features associated with the touchpad that are configured to guide the occupant's finger across a touch sensitive surface of the touchpad. The topographical features help to ensure that the occupant's finger follows one or more predetermined paths which correspond with one or more characters that the character recognition system is configured to recognize. In some embodiments, the topographical features may be attached to, or maybe integral with, a substrate of the touch sensing surface. A touch sensing film may be positioned over the substrate to form the touchpad. In such embodiments, the topographical features are positioned below the touch sensing surface and serve as a guide for character entry while still permitting access to, and use of, the entire touch sensing surface. In other embodiments, topographical features may be positioned over the touch sensing surface as a stencil. In such embodiments, the topographical features would obstruct the occupant from contacting portions of the touch sensing surface that do not correspond with characters that are recognizable to the character recognition system.

In some embodiments, the touchpad may be configured to recognize inputs imparted on the touch sensing surface and to generate a signal that corresponds with the pattern of the occupant's touch. The signal could then be outputted to a one or more controlled systems, each of which may be running character recognition software and each of which may be configured to recognize a character associated with the pattern of the occupant's touch. In other embodiments, the touchpad may be configured to not only recognize inputs imparted on the touch sensing surface by the occupant, but may also run character recognition software and may therefore recognize characters associated with the occupant's touch.

A further understanding of the above described character recognition system may be obtained through a review of the illustrations accompanying this application together with a review of the detailed description that follows.

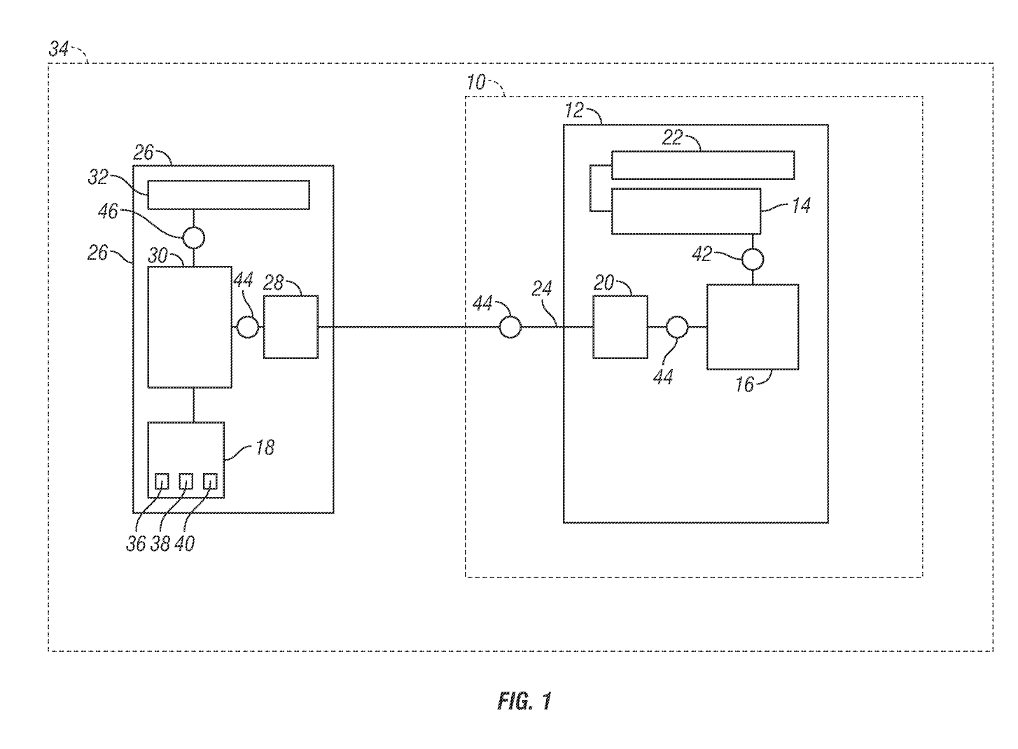

FIG. 1 is a schematic view illustrating various embodiments of a character recognition system. An embodiment 10 of the character recognition system includes a touchpad 12 that includes a touch sensing surface 14, a processor 16, an output device 20, and a topographical feature 22. Embodiment 10 may also include a wire 24 to carry outputs from touchpad 12 to controlled devices. In the illustrated embodiment, touchpad 12 is configured to provide inputs to controlled device 26. Controlled device 26 includes a memory unit 18, an input device 28, a processor 30, and a controlled element 32. Another embodiment 34 of the character recognition system combines touchpad 12 and wire 24 of embodiment 10 with controlled device 26.

Touch sensing surface 14 may employ any suitable touch sensing technology that permits the detection of a user's touch. Multiple technologies exist for detecting a user's touch including those disclosed in U.S. Pat. Nos. 4,521,870; 4,821,031; 5,038,142; 5,956,021; 6,259,491; 6,297,811; and 6,492,979, the disclosures of which are hereby incorporated herein in their entirety by reference. An occupant may use touch sensing surface 14 to input characters into embodiment 10 by sliding their finger, a stylus, or any other suitable input member (referred to herein collectively as a “touching member”) across touch sensing surface 14 in a pattern or shape that resembles a character of a predetermined set of characters. For example, if the set of characters were the English alphabet, then a character of such predetermined set of characters would be the letter “A”.

Topographical feature 22 is associated with touch sensing surface 14 and maybe integral therewith, affixed thereto, positioned adjacent thereto, or otherwise proximate to touch sensing surface 14. Topographical feature 22 may be any suitable member, structure, or feature that, when associated with touch sensing surface 14, tends to guide the touching member in a predetermined pattern that corresponds with the predetermined set of characters. Using the example set forth above of the letter “A”, topographical feature 22 may be a member or a plurality of members that includes one or more raised portions or depressions or any combination thereof that tends to guide the touching member in a pattern that will mimic the letter “A”. The raised portions and/or depressions serve to guide the occupant's touching member so that the occupant may feel their way through the entry of the character without needing to visually observe the touching member as it slides along touch sensing surface 14. For example, a user may move their finger along a raised ridge or a depressed valley and would use the walls of such structure as a guide.

Output device 20 may comprise any suitable device configured to permit the transmission of signals between touchpad 12 and controlled device 26. For example, output device 20 may comprise a port to receive a wire 24, which, for example, may be an Ethernet cable used in the transmission of signals between computer components. In other embodiments, output device 20 may comprise a radio frequency transmitter such as a BlueTooth™ transceiver to permit the wireless transmission of signals between paired components. In such embodiments, there may be no need for wire 24.

Processor 16 may be any type of computer, computer system, microprocessor, collection of logic devices, a state machine, or any other analog or digital circuitry that is configured to calculate, and/or to perform algorithms, and/or to execute software applications, and/or to execute sub-routines, and/or to be loaded with and to execute any type of computer program. Processor 16 may comprise a single processor or a plurality of processors acting in concert.

In the illustrated embodiment, processor 16 is communicatively coupled to touch sensing surface 14 and operatively coupled with output device 20. Such couplings may be accomplished through the use of any suitable means of transmission including both wired and wireless connections. For example, each component may be physically connected to processor 16 via a coaxial cable or via any other type of wire connection that is effective to convey electronic signals. In other embodiments, each component may be coupled to processor 16 across a bus or other similar communication corridor. In still other embodiments, each component may be wirelessly coupled to processor 16. Examples of suitable wireless connections include, but are not limited to, a wireless communication protocol identified by the Bluetooth trademark, a Wi-Fi connection, an infrared connection or the like.

Touch sensing surface 14 is configured to send processor 16 a signal 42 that corresponds to touches detected by touch sensing surface 14. Signal 42 may contain information pertaining to which portion or portions of touch sensing surface 14 have been touched, as well as other information. Processor 16 is configured (e.g., programmed) to receive signal 42 and to utilize signal 42 to detect a pattern of the touch traced by the touching member as it slides across touch sensing surface 14. In some embodiments, processor 16 may compile a plurality of signals 42 to detect the pattern of touch. In some embodiments, the pattern of touch may be determined starting from the moment when the touching member first makes contact with touch sensing surface 14 and ending the moment when touching member ceases making contact with touch sensing surface 14. In other embodiments, the pattern of touch may be determined starting from the moment when the touching member first begins to slide across touch sensing surface 14 and ending when the touching member stops sliding across touch sensing surface 14. Other strategies may also be employed.

In some embodiments, processor 16 may be configured to recognize the pattern of touch imparted by the touching member without regard to the direction or the sequence of touches. For example, processor 16 may be configured to recognize a generally rectangular pattern imparted by the touching member on touch sensing surface 14 regardless of whether the user starts at the lower left hand corner of touch sensing surface and traces in a clockwise direction or if the user starts at the upper right hand corner and traces in a counter-clockwise direction. Rather, in such circumstances, the pattern detected by processor 16 may be identical. In other circumstances, processor 16 may be configured to associate the specific direction of touch with a specific pattern, in which case, the example just given would result in processor 16 recognizing two distinct patterns. The use of direction of trace across touch sensing surface 14 as a discriminator may be appropriate in circumstances where two different characters of a predetermined set of characters are similar.

In other embodiments, the pattern traced by the user may be recognized by processor 16 regardless of its dimension. For example, a rectangular input may be recognized as such by processor 16 regardless of whether the user traces around an entire perimeter of touch sensing surface 14, or around only a portion of the topographical feature that also defines a rectangle. Furthermore, processor 16 may be configured to ignore multiple tracings across the same line segment of the topographical feature, as it may be necessary to move the touching member back and forth across the same portion of the touch sensing surface to trace a particular character without lifting the touching member off of the touch sensitive surface.

Once processor 16 has determined the pattern of touch imparted by the touching member on touch sensing surface 14, processor 16 is configured to generate a signal 44 that corresponds with the pattern of touch detected on the surface of touch sensing surface 14. In some embodiments, signal 44 may contain information that is recognizable by processors running character recognition software. Processor 16 is further configured to instruct output device to deliver signal 44 to controlled device 26. This act may include sending signal 44 out over wire 24 or it may entail wirelessly transmitting signal 44, depending upon how touchpad 12 is configured.

The various components of controlled device 26 are communicatively and/or operatively coupled to processor 30. In an embodiment, processor 30 is communicatively coupled to input device 28 and operatively coupled to memory unit 18 and to controlled element 32. As discussed above, such coupling may be accomplished through either wired or wireless connections which are well known in the art.

Controlled device 26 is configured to receive signal 44 with input device 28. Input device 28 may be configured to be compatible with output device 20. For example, in the illustrated example, output device 20 is a cable port that is configured to receive wire 24. Correspondingly, input device 28 is also be a cable port and is configured to receive wire 24. In other embodiments, such as embodiments where output device 20 is an RF transceiver, input device 28 would be an RF receiver configured to communicatively couple with output device 20. In still other embodiments, input device 28 may comprise any suitable device effective to receive signal 44 from touchpad 12.

Input device 28 delivers signal 44 to processor 30. Processor 30 may be any type of computer, computer system, microprocessor, collection of logic devices, a state machine, or any other analog or digital circuitry that is configured to calculate, and/or to perform algorithms, and/or to execute software applications, and/or to execute sub-routines, and/or to be loaded with and to execute any type of computer program. Processor 30 is loaded with character recognition software and is configured to examine the information contained in signal 44 to determine if the pattern of touch determined by processor 16 corresponds with any character of a predetermined set of characters programmed into processor 30.

In some embodiments, processor 30 may be loaded with software that allows processor 30 to determine if signal 44 corresponds with any character of multiple sets of predetermined characters. In other embodiments, controlled device 26 includes memory unit 18 to assist processor 30 in discerning characters from signal 44. Memory unit 18 is an electronic memory device that is configured to store data. Memory unit 18 may be any type of data storage component including, without limitation, non-volatile memory, disk drives, tape drives, and mass storage devices and may include any suitable software, algorithms and/or sub-routines that provide the data storage component with the capability to store, organize, and permit the retrieval of data. In at least one embodiment, memory unit 18 is configured to store a plurality of different sets of predetermined characters. For example, memory unit 18 may store a predetermined set of characters 36 which may correspond to the English alphabet, a predetermined set of characters 38 which may correspond to the Hebrew alphabet, and a predetermined set of characters 40, which may correspond to the Japanese alphabet. In other embodiments, a greater or lesser number of predetermined sets may also be stored in memory unit 18. By loading memory unit 18 with multiple sets of predetermined characters, controlled device 26 is enabled to receive inputs in multiple languages.

Utilizing techniques well known in the art, processor 30 may be configured to retrieve the predetermined sets of characters from memory unit 18 and may be further configured to determine if signal 44 corresponds with a character of one of the predetermined sets of characters. This process may be repeated for each new signal 44 received from touchpad 12. When a character or a string of characters are recognized by processor 30, processor 30 may generate an instruction 46 corresponding with the characters received and may communicate instruction 46 to controlled element 32 for execution. Controlled element 32 may be any type of electronic device that is responsive to inputs and may further be configured to receive and respond to instructions from processor 30.

Touchpad 12 may be configured to be used with more than one controlled device. In some embodiments, embodiment 10 may be sequentially coupled to multiple controlled devices while in other embodiments, embodiment 10 may be simultaneously coupled with multiple controlled devices. In embodiments where multiple controlled devices are simultaneously connected, a vehicle occupant may designate which of several controlled devices an input is intended for in any suitable manner including, but not limited to, the movement of a suitable switch, the depression of an appropriate button, or the entry of a symbol on touch sensing surface 14 associated with a desired controlled device. This arrangement may be implemented by having touchpad 12 mounted in a vehicle and then plugging in and/or removing various desired controlled devices to touchpad 12, or by simultaneously connecting multiple controlled devices to multiple output devices on touchpad 12 or by wirelessly pairing multiple controlled devices to touchpad 12. Other configurations are also possible.

In other embodiments, such as embodiment 34, touchpad 12 is not configured to be used with multiple controlled devices. Rather, in embodiment 34, controlled device 26 and touchpad 12 are dedicated for exclusive use with one another. In such embodiments, controlled device 26 and touchpad 12 may be packaged in a single housing and be part of a single unit.

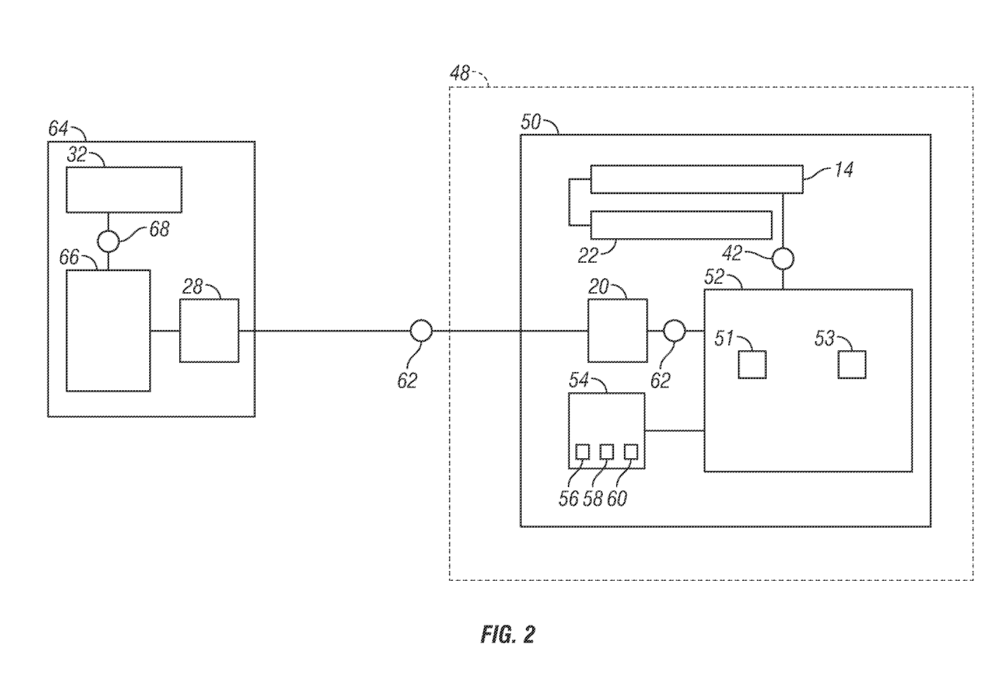

FIG. 2 is a schematic view of another embodiment 48 of a character recognition system. With continuing reference to FIGS. 1-2, embodiment 48 includes touch pad 50 which contains touch sensing surface 14, topographical feature 22 and output device 20. Touchpad 50 also contains a processor 52 and a memory unit 54. Processor 52 is substantially identical to processor 16, but is configured to not only determine a pattern of touch on touch sensing surface 14, but is further configured to recognize characters from the predetermined set or sets of characters, a task which was delegated to controlled device 26 in embodiments 10 and 34. Touchpad 50 also contains memory unit 54 which is substantially identical to memory unit 18, but is now configured to be operatively coupled with processor 52 of touchpad 50 instead of operatively coupled to processor 30 of the controlled device. Memory unit 54 may be configured to store multiple predetermined sets of characters including predetermined set of characters 56, predetermined set of characters 58, and predetermined set of characters 60. In other embodiments, a greater or smaller number of predetermined sets of characters may be stored on memory unit 54, while in still other embodiments, touchpad 50 may not include memory unit 54.

Processor 52 is communicatively coupled with touch sensing surface 14 and is operatively coupled with output device 20 and memory unit 54. Processor 52 is configured with pattern recognition software 51. Accordingly, when processor 52 receives signal 42 from touch sensing surface 14, processor 52 is configured to determine the pattern of touch imparted by the touching member on touch sensing surface 14. In addition, processor 52 is further configured with character recognition software 53 and is therefore able to recognize which character of a predetermined set of characters the pattern of touch corresponds with. Processor 52 may also be configured to retrieve the multiple predetermined sets of characters stored in memory unit 54 when attempting to recognize a character.

Once processor 52 recognizes a predetermined character, processor 52 is configured to generate a signal 62 that corresponds with the character recognized. Processor 52 is further configured to instruct output device 20 to output signal 62 in any suitable manner, as described above with respect to signal 44.

Processor 52 is configured for communicative coupling with controlled device 64 and may be communicatively coupled with controlled device 64 in any suitable manner, as described above. Controlled device 64 is similar to controlled device 26. Controlled device 64 differs from controlled device 26 in that controlled device 64 lacks a memory unit and further in that processor 66 does not perform the character recognition function. Rather, recognized characters are presented to controlled device 64 and processor 66 is configured to generate an instruction 68 in response to the character contained in signal 62. As before, processor 66 is configured to send instruction 68 to controlled element 32 for execution. Touchpad 50 of embodiment 48 is compatible for use with multiple controlled devices and may be communicatively coupled to such multiple controlled devices either simultaneously or sequentially.

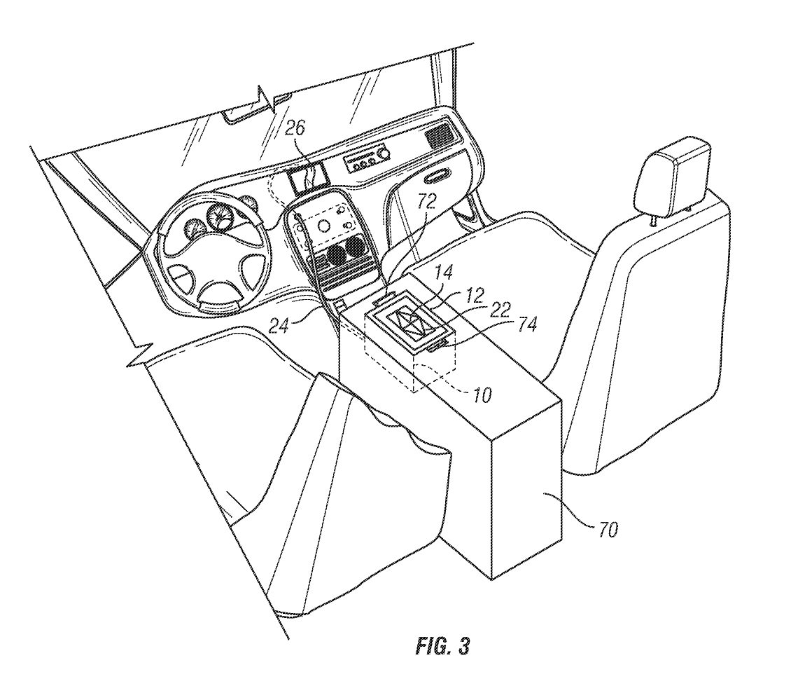

FIG. 3 is a perspective view of the passenger compartment of the vehicle equipped with embodiment 10 of the character recognition system of FIG. 1. It should be understood that although the context of the discussion herein is with respect to a vehicle, the systems and embodiments described herein are not limited to use with a vehicle and may be implemented in virtually any configuration and/or form. In the illustrated embodiment, touchpad 12 may be positioned on a center console 70 inside the passenger compartment. In this location, touchpad 12 is relatively accessible to both a driver and a front seat passenger. In other embodiments, touchpad 12 may be positioned in any suitable location.

Touchpad 12 is connected via wire 24 to controlled device 26, a navigation system. By entering characters on touchpad 12, a vehicle occupant can provide inputs into controlled device 26. Topographical feature 22 is shown proximate with touch sensing surface 14. Topographical feature 22 defines multiple pathways for an occupant's touching member to trace as it moves across the surface of touch sensing surface 14. This allows the occupant to provide input into controlled device 26 without having to divert attention away from the road ahead or from other tasks.

To further facilitate the entry of inputs into embodiment 10 of the character recognition system, additional topographical features may be provided. In the illustrated example, a raised ridge 72 is provided forward of touchpad 12 and a depressed valley 74 is provided rearward of touchpad 12. In other embodiments, any other configuration that is tactilely recognizable may be implemented. In still other embodiments, a greater or lesser number of additional topographical features may be implemented. These additional topographical features allow a user to get their bearings with respect to touchpad 12 by providing a touchable reference point for the occupant to locate before beginning to make entries on touchpad 12. Once the occupant's touching member makes contact with one of these additional topographical features, they will inherently know where the touching member is with respect to the touchpad 12 and also with respect to the various pathways of topographical feature 22.

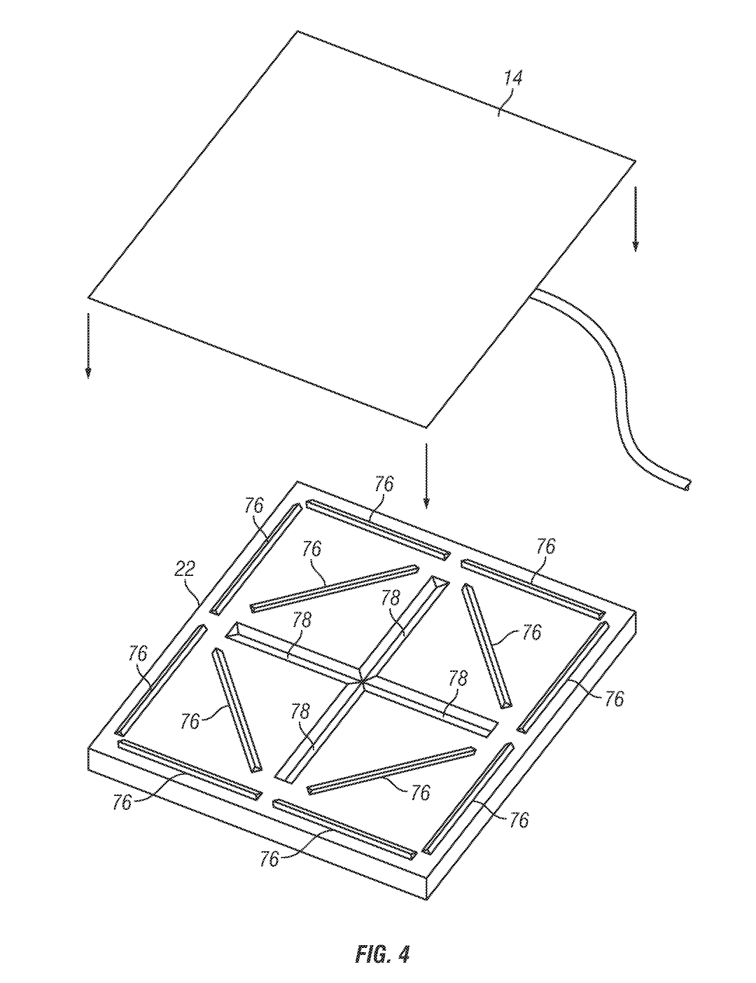

FIG. 4 illustrates touch sensing surface 14 and an embodiment of topographical feature 22. In the illustrated embodiment, topographical feature 22 is a substrate that is configured to be positioned beneath touch sensing surface 14 and to support touch sensing surface 14. Topographical feature 22 includes a plurality of raised surfaces 76 and depressed surfaces 78. Raised surfaces 76 and depressed surfaces 78 extend across substantially an entire surface of topographical feature 22 and form a pattern that corresponds with a set of predetermined characters. In the illustrated embodiment, the set of predetermined characters is the English alphabet and by sliding the touching member along raised surfaces 76 and depressed surfaces 78, an occupant can trace each letter of the English alphabet. When touch sensing surface 14 is lowered onto topographical feature 22, touch sensing surface 14 will take on the contours of topographical feature 22. An occupant attempting to input characters into touchpad 12 will be able to feel raised surfaces 76 and depressed surfaces 78 and will therefore be enabled to correctly and consistently enter recognizable characters into touchpad 12.

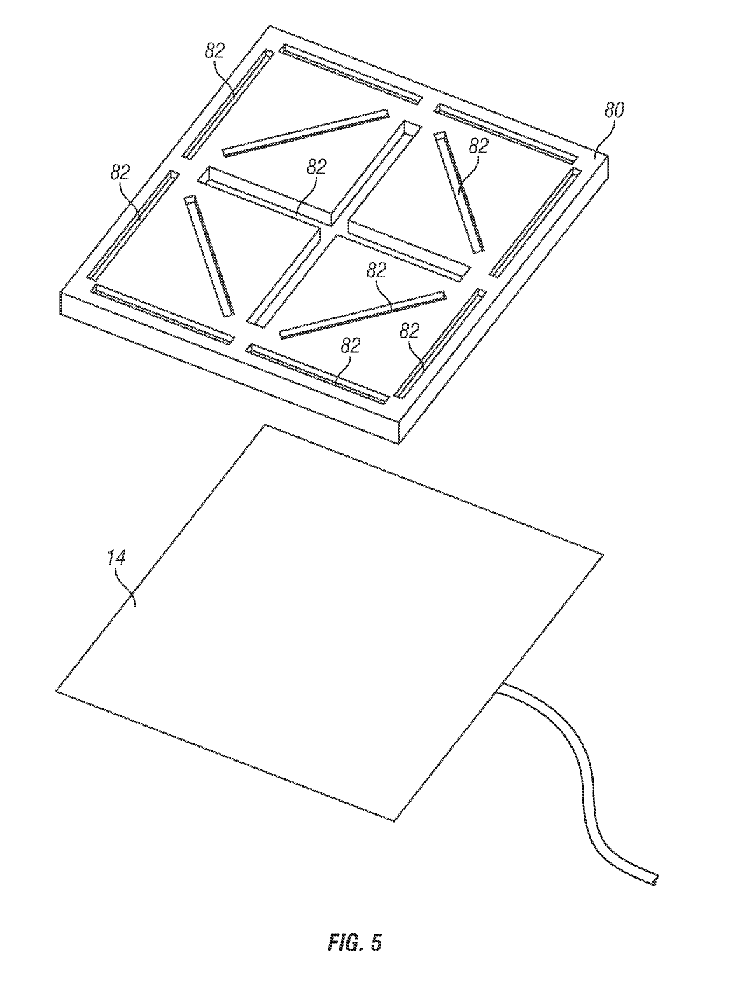

FIG. 5 illustrates touch sensing surface 14 and another embodiment 80 of a topographical feature. With continuing reference to FIGS. 1-5, embodiment 80 comprises a stencil that is configured to fit over touch sensing surface 14. Embodiment 80 includes a plurality of openings 82 that are configured to permit access to portions of touch sensing surface 14 when embodiment 80 is disposed over touch sensing surface 14. Openings 82 are shaped, contoured, and configured to correspond with a predetermined set of characters. A user may run their finger or other touching member over openings 82 to engage touch sensing surface 14 and by tracing the contours of openings 82, the user may engage with those portions of touch sensing member 14 that correspond with the characters of the predetermined set of characters.

In some embodiments, a plurality of stencils may be available for use with touch sensing surface 14, each stencil having a different configuration of openings 82. For each stencil, the pattern of openings 82 may be configured to correspond with the characters of different predetermined sets of characters. For example, a first stencil may be configured to permit the user to input letters of the English alphabet while a second stencil may be configured to permit a user to input letters of the Japanese alphabet. In this manner, the same touch pad could be used to provide inputs into different systems that are configured to recognize the letters of different alphabets. In other examples, such as those where the topographical feature is a substrate (e.g., topographical feature 22 of FIG. 4), the entire touchpad itself may be removable and exchanged with a different touchpad having a different substrate with topographical features that correspond to the characters of a different predetermined set of characters. In this manner, the character recognition system can be tailored and/or modified to accommodate the needs of the user.

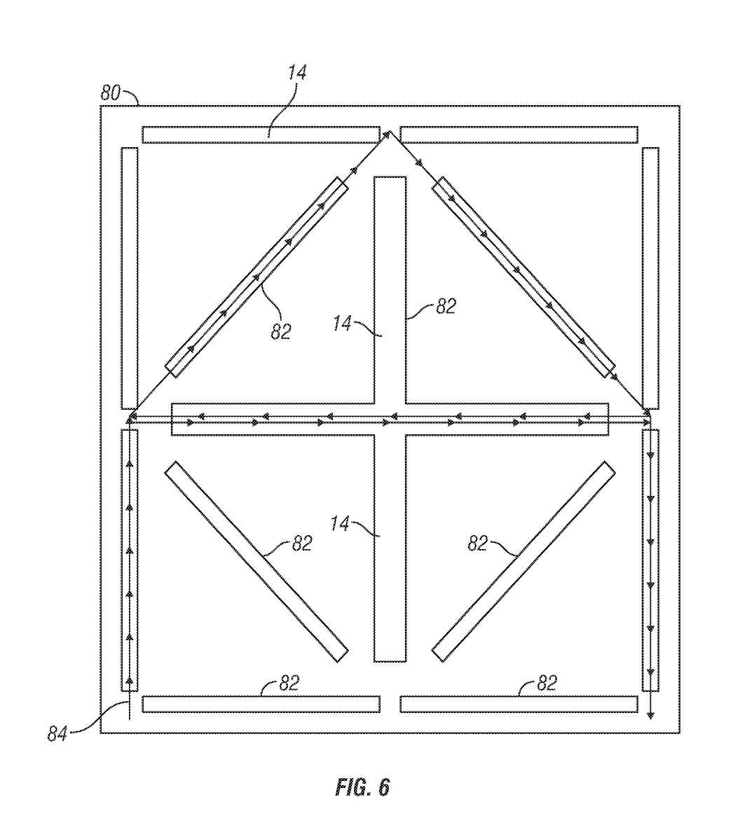

FIG. 6 is a plan view of embodiment 80 positioned over touch sensing surface 14. A line 84 illustrates the path that a user may trace with their finger or other touching implement to input the letter “A”. The user may trace over the indicated openings 82 to engage with touch sensing surface 14. All other letters of the English alphabet may also be traced on touch sensing surface 14 using embodiment 80.

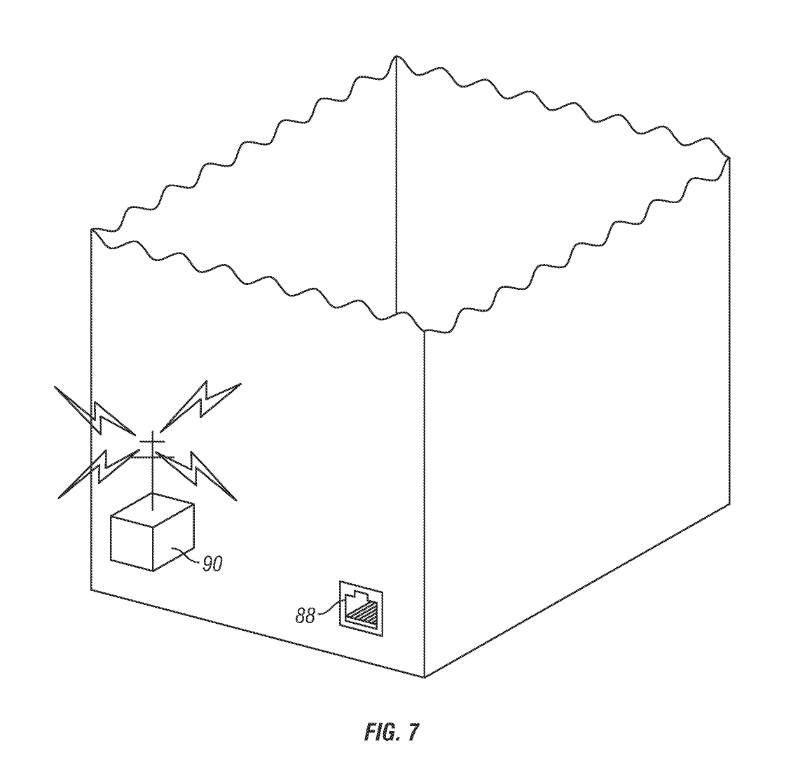

FIG. 7 is a perspective fragmentary view of a portion of a housing 86 for the touch pad of the character recognition system described herein. With continuing reference to FIGS. 1-7, this illustration depicts two mechanisms for outputting the signal generated by processors 16 and 52. An Ethernet port 88 is provided to receive an Ethernet cable. Once the Ethernet cable is connected between the touchpad and the controlled device, the touchpad may be used to input characters into the controlled device. Alternatively, an RF transceiver 90 may be provided to broadcast the signal. In some embodiments, both output devices may be included.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A character recognition system comprising:
a touchpad including a touch sensing surface configured to generate a first signal in response to a touch on the touch sensing surface, the first signal corresponding to a location of the touch on the touch sensing surface, the touchpad further including a topographical feature associated with the touch sensing surface, the topographical feature configured to guide a touching member in a predetermined pattern along the touch sensing surface, the predetermined pattern corresponding with a predetermined set of characters;
an output device configured to be communicatively coupled with a controlled device; and
a processor communicatively coupled with the touchpad and the output device, the processor configured to receive the first signal, to detect a pattern of the touch, to generate a second signal corresponding to the pattern of the touch, and to instruct the output device to output the second signal when the processor generates the second signal.

2. The character recognition system of claim 1, wherein the topographical feature comprises a substrate disposed beneath the touch sensing surface, the substrate having an upper surface that includes a surface feature having an elevation that differs from other portions of the upper surface.

3. The character recognition system of claim 1, wherein the topographical feature comprises a stencil positioned over the touch sensing surface.

4. The character recognition system of claim 1, wherein the topographical feature comprises a valley extending along the touch sensing surface.

5. Character recognition system of claim 1, wherein the topographical feature extends along a central portion of the touch sensing surface.

6. The character recognition system of claim 1, the touchpad including a plurality of discrete features associated with the topographical feature, each discrete feature configured to guide the touching member in a respective predetermined pattern along the touch sensing surface, each respective predetermined pattern corresponding with the predetermined set of characters.

7. The character recognition system claim 1, wherein the touchpad further includes a second topographical feature positioned adjacent the touch sensing surface to provide a user with a consistent starting location for entry of characters on the touchpad.

8. The character recognition system of claim 7, wherein the second topographical feature comprises an elevated surface.

9. The character recognition system of claim 7, wherein the second topographical feature comprises a depressed surface.

10. The character recognition system of claim 1, wherein the output device is configured to be coupled with the controlled device via a wire.

11. The character recognition system of claim 1, wherein the output device is configured to be wirelessly coupled with the controlled device.

12. A character recognition system comprising:
a touchpad including a touch sensing surface configured to generate a first signal in response to a touch on the touch sensing surface, the first signal corresponding to a location of the touch on the touch sensing surface, the touchpad further including a topographical feature associated with the touch sensing surface, the topographical feature configured to guide a touching member in a predetermined pattern along the touch sensing surface, the predetermined pattern corresponding with a predetermined set of characters;
an output device;
a first processor communicatively coupled with the touchpad and the output device, the first processor configured to receive the first signal, to detect a pattern of the touch, to generate a second signal corresponding to the pattern of the touch, and to instruct the output device to output the second signal when the first processor generates the second signal; and
a controlled device communicatively coupled with the output device, the controlled device configured to receive the second signal from the output device, the controlled device including a controlled element and a second processor coupled to the controlled element, the second processor configured to recognize the predetermined set of characters and to send an instruction to the controlled element when the second processor determines that the second signal corresponds with a character of the predetermined set of characters.

13. The character recognition system of claim 12, further comprising a memory unit operatively coupled with the second processor, wherein the memory unit is configured to store the predetermined set of characters and the second processor is further configured to access the predetermined set of characters from the memory unit.

14. The character recognition system of claim 13, wherein the memory unit is further configured to store a plurality of predetermined sets of characters and wherein the second processor is further configured to access the plurality of predetermined sets of characters.

15. The character recognition system of claim 12, wherein the topographical feature comprises a substrate disposed beneath the touch sensing surface, the substrate having an upper surface that includes a surface feature having an elevation that differs from other portions of the upper surface.

16. The character recognition system of claim 12, wherein the topographical feature comprises a stencil positioned over the touch sensing surface.

17. The character recognition system of claim 12, wherein the topographical feature comprises a valley extending along the touch sensing surface.

18. A character recognition system comprising:
a touchpad including a touch sensing surface configured to generate a first signal in response to a touch on the touch sensing surface, the first signal corresponding to a location of the touch on the touch sensing surface, the touchpad further including a topographical feature associated with the touch sensing surface, the topographical feature configured to guide a touching member in a predetermined pattern along the touch sensing surface, the predetermined pattern corresponding with a predetermined set of characters;
an output device configured to be communicatively coupled with a controlled device; and
a processor communicatively coupled with the touchpad and the output device, the processor configured to receive the first signal, to detect a pattern of the touch, to recognize the predetermined set of characters, to generate a second signal corresponding to a character of the predetermined set of characters when the pattern of the touch corresponds with the character, and to instruct the output device to output the second signal to the controlled device when the processor generates the second signal.

19. The character recognition system of claim 18, further comprising a memory unit operatively coupled with the processor, the memory unit configured to store the predetermined set of characters and the processor further configured to access the predetermined set of characters from the memory unit.

20. The character recognition system of claim 19, wherein the memory unit is further configured to store a plurality of predetermined sets of characters and wherein the processor is further configured to access the plurality of predetermined sets of characters.
